(19) United States
(12) Patent Application Publication
(10) Pub. No.: US 2009/0254433 A1
(43) Pub. Date: Oct. 8, 2009

(54) METHOD AND SYSTEM FOR IMPROVING NETWORK INFORMATION RESOURCE DISTRIBUTION

(76) Inventor: Weibin Cao, Beijing (CN)

Correspondence Address: MARGER JOHNSON & MCCOLLOM, P.C., 210 SW MORRISON STREET, SUITE 400, PORTLAND, OR, 97204, US

(21) Appl. No.: 11/817,861

(22) PCT Filed: Aug. 20, 2007
(86) PCT No.: PCT/CN2007/070523

§ 371 Date: Sep. 13, 2007

(30) Foreign Application Priority Data
Aug. 6, 2007 (CN) 200710120001.X

(51) Int. Cl. G06Q 30/00; G06N 7/02; G06F 7/58; G06F 15/16; G06F 17/00

(52) U.S. Cl. 705/14.45; 706/52; 708/254; 709/203; 705/14.4; 715/234

(57) ABSTRACT

The present invention discloses a method and a system for improving network information resource distribution, to solve the issue that the conventional information resource distribution has not fully utilized the network resources and thus rendered a lower distribution rate and utilization rate of information resources. The method includes: making a statistics on virtual sites distributing information resources, and calculating utilization rate of the information resources on each of the virtual sites; assigning a corresponding probability of obtaining a priority to each of the virtual sites according to the utilization rate; selecting randomly a virtual site by using the probability for obtaining a priority of each of the virtual sites; assigning a priority to the selected virtual site; distributing the information resources corresponding to the priority by virtual sites which have not distributed the information resources, according to the priority. The system includes a statistics sub-system and an assignment sub-system.

The present invention claims priority to Chinese Application No. 200710120001.X, filed on Aug. 6, 2007 and entitled “Method and System for improving network information resource distribution”, contents of which are incorporated herein by reference in its entirety.

### FIELD OF THE INVENTION

The present invention relates to the field of network technologies, and more particularly to a method and a system for improving network information resource distribution.

### BACKGROUND OF THE INVENTION

The development of networks provides convenience for dissemination and interaction of various information. A conventional distribution of network information resources is illustrated in FIG. 1. In the Internet environment, owners of information resources distribute their respective information resources to multiple virtual sites 102 (for example, the four virtual sites 1 to 4 designated as 102, as shown in FIG. 1) through a distribution system 101 for presentation. In practice, the information resources are presented as network advertisements displayed in various forms such as text, picture, sound or multimedia; and the virtual sites 102 each refer to the entire contents on a website or a collection of contents contained on a website which are interrelated and independent from each other. For example, a virtual site may be a Blog Service Provider (BSP) or a blog hosted on the BSP by a particular person. The distribution system 101 is a management system for the multiple virtual sites 102, such as website for hosting blogs or an alliance of multiple websites. An issue of the conventional distribution of network information resources lies in that the distribution of the information resources is subjected to the influence of page access count. If the access count is low, the number of the virtual sites for distributing the information resource is small, resulting in low distribution rate and utilization rate of the information resources.

Taking a website for hosting blogs as an example, a person may log on the website to apply for setting up his blog. To manage various advertisement information putted in the website, the website distributes the advertisement information into different categories of columns for presentation. Because a blog is a personal space on the network and has a relative freedom, the advertisement information presented in the blog needs to be applied by the owner of the blog. To attracting blog owners, some websites give a certain reward to the blogs putting advertisements. For example, the value of the advertisements is evaluated according to advertisement putting amount and click times, and then is converted into cash revenue or scores and returned to the blog. Therefore, the distribution of a website's advertisements in a blog is subjected to the access count of the blog. The higher the access count of the blog is, the more the blog will earn from advertisements, which will arouse high enthusiasm of the blog owners to put advertisements. As a result, the advertisements on the website may be distributed to more blogs for presentation.

For a virtual site with small access traffic, for example, the site will not apply for presenting various information resources because of the low resource value generated by the site. Thus the distribution of the information resources will have a loss from the great deal of virtual sites with small access traffic, and low distribution will result in low utilization rate of the information. As a result, the conventional information distribution has not fully utilized the network for the purpose of presentation, dissemination and communication, rendering low utilization rate of network resources.

### SUMMARY OF THE INVENTION

The present invention provides a method and a system for improving network information resource distribution, so as to solve the issue that the conventional information resource distribution has not fully utilized the network resources and thus rendered a lower distribution rate and utilization rate of information resources.

To solve the above issue, according to an embodiment of the present invention, the present invention discloses the following technical solutions.

A method for improving network information resource distribution includes:

making a statistics on virtual sites distributing information resources, and calculating utilization rate of the information resources on each of the virtual sites;

assigning a corresponding probability of obtaining a priority to each of the virtual sites according to the utilization rate;

selecting randomly a virtual site by using the probability for obtaining a priority of each of the virtual sites;

assigning a priority to the selected virtual site;

according to the priority, distributing the information resources corresponding to the priority by virtual sites which have not distributed the information resources.

The process of selecting randomly a virtual site by using the probability for obtaining a priority of each of the virtual sites comprises: implementing the obtaining a priority by assigning a corresponding quantity of numbers to each of the virtual sites according to the utilization rate of the information resources; selecting one or more numbers randomly from all the numbers through a random algorithm; assigning a priority to the virtual site or sites to which the selected number or numbers belong.

The implementation of the random selection process includes: collecting a number of raw data, and treating the raw data with a mathematic conversion to obtain an output data; generating a random sequence through a random sequence generation function using the output data as a random seed; each value in the random sequence corresponding to one of the numbers.

The method further includes distributing the information resources to the virtual site by embedding a dynamic Flash or a dynamic script on the virtual site.

The information resources are network advertisements, the utilization rate of the information resources is advertisement revenue, and the priority refers to the advertisement revenue reassigned to the selected virtual site.

A system for improving network information resource distribution includes:

a statistics sub-system, used to make a statistics on virtual sites distributing information resources and calculate utilization rate of the information resources on each of the virtual sites;

an assignment sub-system, used to assign a corresponding probability of obtaining a priority to each of the virtual sites according to the utilization rate, select randomly a virtual site through a verifiable random sequence generation approach by using the probability for obtaining a priority of each of the virtual sites, assign a priority to the selected virtual site, and distribute the information resources corresponding to the priority on virtual sites which have not distributed the information resources according to the priority.

An assignment unit, used to assign a corresponding probability of obtaining a priority to each of the virtual sites according to the utilization rate;

a selection unit, used to select randomly a virtual site through a verifiable random sequence generation approach by using the probability for obtaining a priority of each of the virtual sites;

an assignment unit, used to assign a priority to the selected virtual site;

an information distribution unit, used to distribute the information resources corresponding to the priority on the virtual sites which have not distributed the information resources according to the priority.

The system further includes an advertisement distribution sub-system. The advertisement distribution sub-system is used to distribute the information resources to the virtual site by embedding a dynamic Flash or a dynamic script on the virtual site.

According to an embodiment of the present invention, the present invention provides the following technical effects.

Firstly, for the issue of low distribution rate of information resources, an embodiment of the present invention calculates the utilization rate of the information resources, assigns the probability of obtaining a priority to the virtual sites according to the utilization rate, and then selects a virtual site randomly through a verifiable random sequence generation approach by using the probability for obtaining a priority, and assigns a priority to the selected virtual site. The process attracts more sites to distribute the information resources by assigning a priority to the randomly selected virtual site, thus enlarging the distribution of the information resources and improving the utilization rate of the information resources on the virtual sites.

For applications in which the information resources are network advertisements, the method reassigns the direct revenue brought by the advertisements putted in the virtual sites in a way of rewarding a virtual site randomly. The rewarded site may get advertisement revenue greater than its direct revenue. Therefore, more websites will be attracted to put advertisements, thus improving the coverage of the advertisements due to a full utilization of the network. The present invention enables the advertisement putting not to be influenced by the access count. A virtual site with small access traffic has a chance to be rewarded as long as it puts advertisements, and thus the attraction of the virtual site to the advertisement service is increased. In this way, the present invention may effectively converge a great deal of virtual sites with small traffic and develop the advertisement value thereof.

Secondly, during the process of reassigning the advertisement revenue, the generation of the random seed is verifiable. In other words, it is verifiable that the fraud of the random seed is impossible, and consequently the random sequence obtained by substituting the seed into the random function is also verifiable. In this way, the justice for the virtual sites to be awarded may be ensured and the fraud may be prevented.

Thirdly, the advertisements are distributed to the virtual sites through a dynamic Flash or a dynamic script. In other words, a segment of codes are inserted into a webpage. The segment of codes functions to request an appropriate advertisement and present the advertisement when the webpage is browsed. The segment of codes may request advertisements with different contents. In contrast, in a static distribution mode, the codes are bound with a advertisement content and thus may present only an advertisement with the fixed content. Therefore, the dynamic distribution mode is more flexible.

### BRIEF DESCRIPTION OF THE DRAWINGS

FIG. 1 is a diagram illustrating a distribution of network information resources in the prior art.

FIG. 2 is a flow chart illustrating a method for improving information resource distribution of the present invention.

FIG. 3 is a flow chart illustrating an application embodiment of the method as shown in FIG. 2.

FIG. 4 is a structure diagram illustrating an embodiment of a system for improving information resource distribution of the present invention.

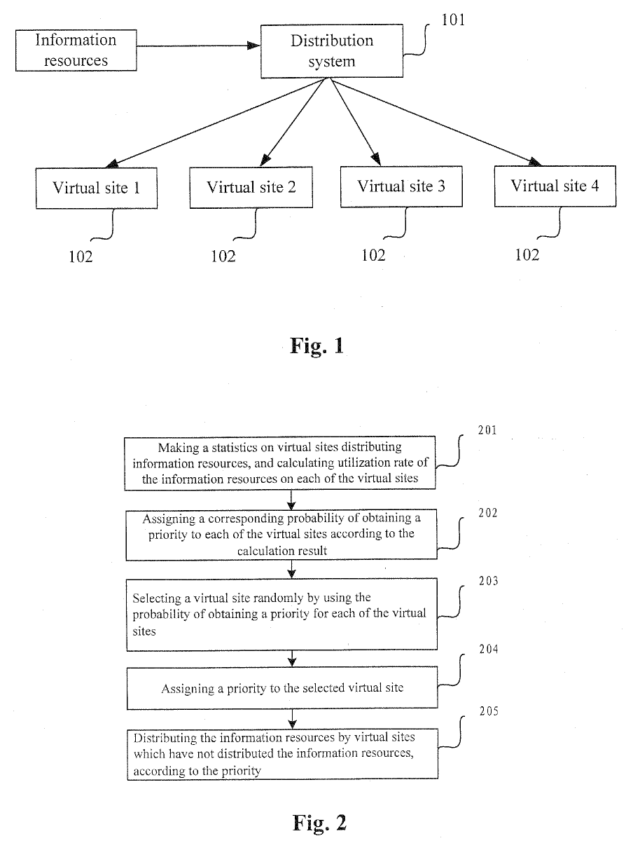

### DETAILED DESCRIPTION OF THE EMBODIMENTS

The present invention will be described hereunder in detail with reference to the accompanying drawings and embodiments of the present invention, so as to make the above objects, features and advantages of the present invention more apparent.

The present invention provides a method for improving information resource distribution. FIG. 2 is a flow chart illustrating the method.

In process 201, a statistics is made on the virtual sites for distributing the information resources, and utilization rate of each of the information resources is calculates for each of the virtual sites respectively. The utilization rate of the information resource in a virtual site may be reflected with the presentation times and times of clicking the information resource by users in a statistic time period, etc. For an instance, for a certain virtual site, if the virtual site is accessed for many times, the information resources presented on the virtual site are browsed for many times consequently. Moreover, if users click the information resources while browsing the virtual site, a better effect will be achieved for the presentation of the information resources.

In process 202, a probability of obtaining a priority is assigned to each of the virtual sites according to the calculating result. In other words, for each virtual site, a corresponding probability of obtaining a priority is assigned to the virtual site according to the result of calculating the utilization rate of the information resources. The probability of obtaining a priority may be in many forms. For an instance, the probability may be presented by assigning a corresponding quantity of numbers; the quantity of the numbers is closely related with the probability; and the higher the probability is, the greater the quantity of the assigned numbers is. Then in the following processes, the chance for a virtual site to be selected will be higher, that is, the probability of obtaining a priority for the virtual site is higher. Here, the numbers are different from each other, and the approach for assigning the numbers is not limited. The priority, as a type of resource, is assigned only to a randomly selected virtual site. The virtual site obtained the priority may enjoy more advantages than other virtual sites on even ground.

There may be other forms to present the probability of obtaining a priority for a virtual site than the form of number, and those forms will not be limited herein by the present invention.

In process 203, a virtual site is selected randomly by using the probability of obtaining a priority for each of the virtual sites. The used random algorithm includes: collecting a number of raw data, and treating the raw data with a mathematic conversion to obtain an output data; generating a random sequence through a random sequence generation function using the output data as a random seed; each value in the random sequence corresponding to one of the numbers. In other words, the random selecting process in the random algorithm is implemented as follows.

A number of raw data are collected. The raw data are treated with a mathematic conversion and then an output data is obtained. A random sequence is generated through a random sequence generation function by using the output data as a random seed. Each value in the sequence corresponds to one of the numbers. Here, the raw data are verifiable, independent, random and distributed evenly to a certain extent. The mathematic conversion refers to rendering the raw data distributed evenly through a one-way function. The random process is verifiable because all the data and the treating method used in the process are open.

The above numbers may be assigned in such a verifiable random sequence generation approach, that is, by selecting one or more numbers randomly from all the numbers.

The random numbers in the random sequence are generated by substituting a random seed into the random sequence generation function for calculation, thus obtaining the random sequence. Each number in the sequence corresponds to one of the above numbers. In conventional random algorithms, the random seed is not verifiable. Even all the data and the algorithm processes are open, it is still impossible to verify that there is no fraud occurring in the random seed. Therefore the whole random process is not verifiable. Consequently, fraud may be introduced in the random process so as to obtain a desired random number.

The present invention prevents the occurrence of such fraud by employing a verifiable random sequence generation approach. The random seed generation process in this method is verifiable, and thus the obtained random sequence is also verifiable. Two verifiable random seed generation processes will be described hereunder.

In one verifiable random seed generation process, a great amount of financial data, such as the digits of the closing prices of N particular stocks in a future day (D), are taken in a certain order to constitute a string S with a length of N, and a mathematic conversion is performed on the S with a conversion function y=f(x). The result of converting S is the random seed. Because the rule and process for generating the string S are open and may be determined uniquely after the time D, the resulting random sequence is verifiable.

In the other verifiable random seed generation process, the verifiability of the random seed is ensured by utilizing the fact that the inverse function of the conversion function is unable to be resolved. In other words, for the random seed conversion function y=f(x), y may be obtained by substituting x into the function f, while the inverse function x=f(y) of the conversion function is unable to be resolved and it is unable to obtain x according to y. Considering y as a random seed, during the process of calculating a different random seed according to a different x, x is known in advance, and y is a calculated result and may not be known in advance. If a fraud random seed is desired, that is, the y to be obtained is predetermined, the x corresponding to y may not be obtained even if y is specified, because x may not be obtained by the inverse function of the conversion function according to y. That is to say, it is impossible to calculate a desired fraud y by specifying a particular x in advance. Thus it may be ensured that the generated y is not a fraud, that is, y is verifiable.

The function y=f(x) is referred to as a conversion function, which means that a different y is calculated for a different x. In other words, the random seed obtained is different and random each time. Therefore the random sequence obtained by substituting each random seed into the random sequence generation function for calculation is also different and random, thus ensuring the random of each random sequence.

The conversion function y=f(x) has the features of one-way, immediacy, collision-resistance and avalanche effect as follows.

(1) For a known output of the function f, it is difficult to obtain the input of a function f; in other words, for a known c=f(m), it is difficult to obtain m; this shows the one-way feature of the function.

(2) For a known m, it is easy to calculate the f(m), which shows the immediacy feature of the function.

(3) For a known f(m1)=c1, it is difficult to constitute an m2 to render f(m2)=c1, which shows the collision-resistance feature of the function.

(4) For c=f(m), each bit in C is related to and highly sensible to each bit in m; in other words, any change to a bit in m will significantly affect c; this shows the avalanche effect feature of the function.

An exemplary calculation process for generating the random seed is described hereunder. Assuming m*n persons in a certain order, each designated with a number, are divided into n groups, and n groups of m−digit numbers (X1, X2, . . . , Xn) are generated. Only each of the members in the same group can see the numbers of other members in the group.

It is assumed the function is y=f(x,z); then Yi=f(Xi, Yi−1).

In the function, i is an integral number ranged from 1 to n, Y0 is any certain number, and Xn+1 is a number which is uncertain at current and verifiable in future; Xi is a group of numbers selected from the n groups of numbers; the function f ensures that it is unable to obtain x according to y.

When Xn+1 can be determined, Yn+1 may be obtained through n+1 times of calculation. A random sequence is generated by substituting Yn+1 as a random seed into the random function. Each random number in the random sequence corresponds to one of the above numbers. Here all the algorithms and data may be open, thus it is verifiable. The present invention does not limit the selection of the random function.

In the above random seed calculation process, it is preferable to perform the calculation with Xn+1 after the n times of calculation. Although the seed obtained through the n times of calculation is random, selecting a random Xn+1 for calculation prevents a fraud of the whole calculation process and ensures the final resulting seed is random. Accordingly, after the n times of calculation, one or more random data (for example, Xn+1, Xn+2, . . . ) may be obtained by configuring open rules. These data are uncertain and random before a particular time point (for example, before the n times of calculation) and are open and knowable after the time point (n). According to the avalanche effect of the conversion function, the result calculated by using these data is taken as the seed influencing the generation of the random sequence generation function. The key to ensure the random and the justice is to select an appropriate seed, that is to say, the quality of the random sequence generation is ensured as long as the random and justice of the random seed is ensured. Due to that the conventional single-selected seed can't achieve the desired effect, multiple random seeds are introduced. The multiple random seeds are interfered by each other through the conversion function, so as to ensure the quality of the final resulting random seed. In the above example, the process of generating n groups of m-digit number from the m*n persons is the process of generating n random seeds. After the random seeds are interfered by each other through the conversion function, a final resulting random seed is obtained. Therefore it is a key to select a number of random seeds independent from each other and influence the final seed through the conversion function. The conversion function is an assistant functionality.

A method for calculating the random seed according to an embodiment of the present invention is to select a great amount of webpages and calculate the html text in each of the webpages to obtain a series of numeral values. For an instance, for n independent webpages, a numeral value sequence Y1, Y2, . . . , Yn may be obtained by calculating the number of characters contained in the text of each of the webpages through a function y=f(x). A numeral value may be obtained through n times of calculation by substituting Y1, Y2, . . . , Yn respectively as a variable into a function g. A random sequence can be generated by substituting the numeral value as a random seed into the random function for calculation. Each random number in the random sequence corresponds to one of the numbers. The function g may be an addition operation or other more complex operations, and the present invention does not limit the selection of the function g the random function. Additionally, the present invention does not limit the calculation of the webpage text.

In the above process, when n is big enough, the numeral value calculated by the function g is a result unable to be known in advance. For example, the result of adding the number of characters in all the webpages will be a great number and may not be obtained by fraud. Therefore the resulting random seed is verifiable and may not be obtained by fraud.

Both of the two random algorithms as described above can ensure verifiability of the random process, thereby avoiding the generation of random number with fraud.

In process 204, a priority is assigned to the selected virtual site. In other words, the number generated randomly is taken as a selected number, and a priority is assigned to the virtual site to which the selected number is belonged. The priority as a kind of resource is assigned only to the virtual site randomly selected. The virtual site obtaining the priority may enjoy more advantages than other virtual sites on even ground. In practice, the priority may have many forms such as score, currency or goods, etc.

In process 205, according to the priority, other virtual sites that have not distributed information resources distribute the information resources corresponding to the priority. The virtual sites that have not distributed information resources will distribute the information resources on their sites in order to obtain the priority. During the above process, the other virtual sites have no chance to obtain the priority because they are unable to attend the random assignment of the priority. Therefore, to obtain a priority, the other virtual sites will distribute various information resources on their sites so as to attend the random assignment of the priority and obtain an assignment chance. In this way, the information resources will be distributed to more virtual sites for presentation, thereby improving the distribution rate and utilization rate of the information resources by fully using the network.

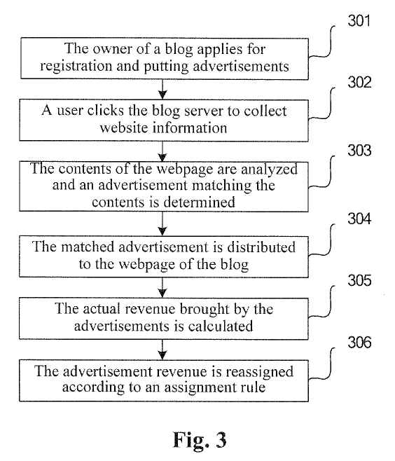

As an example, the distribution of network advertisements on website blogs will be described hereunder in detail. FIG. 3 is a flow chart illustrating an embodiment for the network advertisements. In the embodiment, the virtual site refers to a blog hosted in a website, and the information resources refer to advertisement information.

In process 301, the owner of a blog applies for registration and putting advertisements. The website provides a management window for managing the distribution of various categories of advertisements putted in the website on the pages of the website. The owner of the blog enters the management page and applies for registration and putting advertisements codes. Since the blog is a personal space, putting the advertisements in a blog needs to be applied by the owner of the blog. The blog owner can select advertisement key words or categories related to the contents of his blog, or make a choice freely according to his requirement.

In process 302, a user clicks the blog server to collect website information. When the user logs on the website and enters the blog site, the website server will collect the information of a page browsed by the user with a webpage grabbing tool and save the information in the page.

In process 303, the contents of the webpage are analyzed and an advertisement matching the contents is determined. The website server analyzes the grabbed contents of the page, and calculates the semantic space of the webpage by a series of operations including word splitting, filtering and the like. Then an advertisement related to the kernel contents of the webpage is matched from an advertisement bank. There are many approaches for managing advertisement information in the advertisement bank, among which the most common approach is to categorize the advertisement information according to advertisement key words and set up indexes for the advertisement information. In this way, the advertisement key words appropriate for the kernel contents of the webpage may be searched when matching the advertisement.

In process 304, the matched advertisement is distributed to the webpage of the blog. The advertisement may be distributed in many ways. There are a static distribution mode and a dynamic distribution mode. The static distribution mode refers to that the advertisement codes embedded in the webpage is bound with the content of the advertisement, and only fixed advertisement content may be displayed on the webpage. The dynamic distribution mode refers to that the advertisement codes embedded in the webpage can present advertisements with various contents to the browser.

This embodiment employs the dynamic distribution mode for advertisements. When the webpage of the blog is opened, the advertisement codes embedded in the webpage will send a request to the server automatically and then present an appropriate advertisement to the browser. The dynamic distribution mode may be implemented in a form of Flash, i.e., by playing advertisements in Flash. In other words, when advertisements are putted in the blog site, what putted in the webpage is a Flash player. The flash player can play advertisements with different contents depending on the different putted advertisements. Different from the conventional mode in which one advertisement content is made into one Flash, the embodiment of the present invention may play multiple advertisements with different contents through one Flash carrier. The dynamic distribution mode may also be implemented in a form of dynamic script. For an instance, different advertisement contents may be displayed by putting JavaScript codes or IFrame codes in the webpage. It can be seen that the dynamic distribution mode is more flexible than the static distribution mode.

In process 305, the actual revenue brought by the advertisements is calculated. The advertisements putted in the blog site will bring certain actual revenue according to the presentation effect of the advertisements. The website will calculate the advertisement revenue of each blog site. As stated above, the actual revenue brought by the advertisements may be calculated with reference to the browsing and clicking conditions of the advertisements and subsequent effect and according to the initial prices of the advertisements. The subsequent effect refers to the subsequent purchase activities brought by the advertisements. For example, a user clicks and enters the page of an advertisement after browsing the advertisement and performs a purchase and a payment operation on the network, thus the subsequent effect of the advertisement brings actual purchase revenue to the merchant. One of the above conditions may be considered solely or several conditions may be considered synthetically when calculating the advertisement revenue. Other influence factors may also be considered in the calculation.

In process 306, the advertisement revenue is reassigned according to a distribution rule. The revenue is distributed according to the distribution rule on the basis of the actual advertisement revenue. The revenue assignment rule employs a verifiable random sequence generation approach as stated above. A site may be selected randomly from all the blog sites on the website as a blog to be rewarded, and the advertisement revenue is assigned to the blog to be rewarded according to a certain rule.

For an instance, assuming the address of a blog is http://blog.sina.com.cn/heweifang, advertisement platform codes according to the present invention are disposed in the webpage of the blog. An advertisement will be presented in the webpage when a user accesses the webpage of the blog. Once the user clicks the advertisement, it brings a 0.5 yuan of advertisement revenue. The total advertisement revenue is 2 yuan in a certain time period (e.g., a week), and then the calculated actual advertisement revenue is 2 yuan.

In the process of distributing the advertisement revenue, the blog may provide part or all of its advertisement revenue, for example, 2 yuan, for assignment. Assuming the basic assignment unit is 1 yuan, the blog may obtain two revenue numbers (the numbers may be assigned randomly or selected by the user), for example, 12345 and 54321, with the 2 yuan of revenue. The system collects all the revenue numbers and generates a corresponding number to be rewarded by the verifiable random algorithm according to a certain rewarding rule (for example, a number of first prizes with 10000 yuan, second prizes with 1000 yuan and third prizes with 10 yuan). If the revenue number 54321 of the blog obtains a third prize, the owner of the blog will get 10 yuan of revenue.

The verifiable random algorithm may prevent fraud in the revenue assignment process, and ensure the justice of the advertisement revenue assignment. Thus each blog owner putting advertisements in his blog will have a chance to be rewarded, thereby being assigned with more revenue than his actual revenue. Such a random assignment of advertisement revenue can attract more blogs to put advertisements. Especially for those virtual sites with small access traffic, the virtual sites may have a chance of obtaining more revenue as long as attending the advertisement putting. In this way the coverage of advertisements is enlarged and the advertisement information may be putted in more sites through the network, thereby enlarging the distribution on the network sites. Moreover, the access count of a site will not influence the distribution of the advertisements, because a site with a low access count may also be rewarded and thus may attend the advertisement putting positively. The access count will influence only the reward probability of the sites. The higher the access count is, the more the numbers are assigned to the site, and then the probability for the numbers being randomly selected will be increased. Compared with the conventional direct advertisement revenue assignment, the present invention can effectively converge a great deal of virtual sites with small traffic and develop the advertisement value thereof.

Preferably, during the advertisement revenue assignment process, the advertisement revenue generated by fraud may be filtered out and deducted. For an instance, the owner of a blog clicks the advertisement putted in the blog for many times, and then the advertisement click rate of the blog will increase abnormally. By analyzing the access regularity for the advertisements on a site, it may be determined that a sudden change of the regularity indicates a result of fraud. The advertisement revenue brought by fraud will be filtered when calculating revenue, thereby ensuring the justice of the revenue assignment.

In addition, the advertisement may be assigned to the sites in other forms such as presenting scores to the sites. A site obtaining more scores can enjoy particular advantages on the website, or the beneficiary of the site allied with a merchant may change the scores into goods for free. The present invention does not limit the assignment forms.

The present invention also provides a system for improving network information resource distribution. The system includes a statistics sub-system and an assignment sub-system. The statistics sub-system is used to make a statistics on virtual sites distributing information resources and calculate utilization rate of the information resources on each of the virtual sites. The assignment sub-system is used to assign a corresponding probability of obtaining a priority to each of the virtual sites according to the utilization rate, select randomly a virtual site through a verifiable random sequence generation approach by using the probability for obtaining a priority of each of the virtual sites, assign a priority to the selected virtual site, and distribute the information resources on virtual sites which have not distributed the information resources, according to the priority.

The assignment sub-system includes a probability assignment unit, a virtual site selection unit, a priority assignment unit and an information distribution unit. The probability assignment unit is used to assign a corresponding probability of obtaining a priority to each of the virtual sites. The virtual site selection unit is used to select randomly a virtual site through a verifiable random sequence generation approach by using the probability for obtaining a priority of each of the virtual sites. The priority assignment unit is used to assign a priority to the selected virtual site. The information distribution unit is used to distribute the information resources on the virtual sites which have not distributed the information resources, according to the priority.

The functions and purposes of the sub-systems in the system may be understood by referring to the implementation of the processes in the method as described above, and thus will not be repeated here.

Preferably, the system may also include an advertisement distribution sub-system. The advertisement distribution sub-system is used to distribute various information resources to a virtual site by embedding a dynamic Flash or a dynamic script on the virtual site.

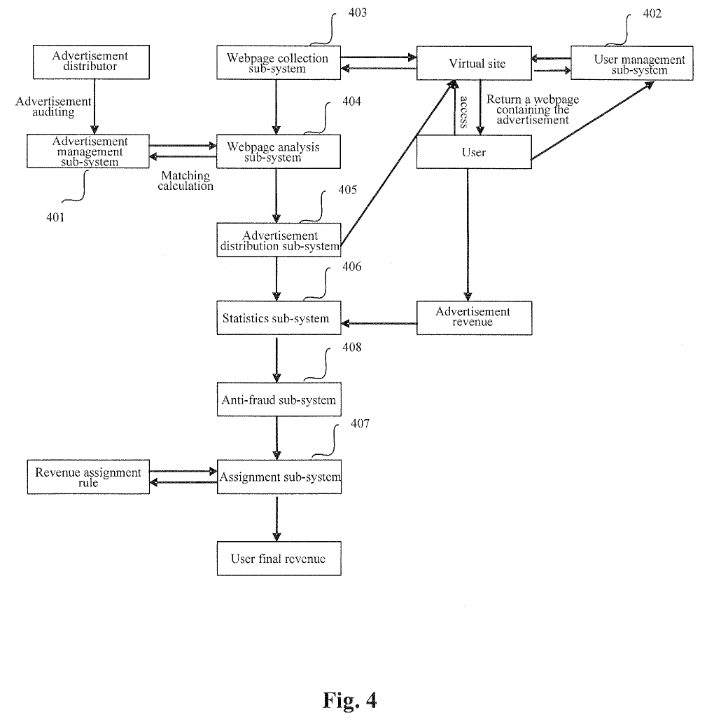

The present invention also provides an embodiment of the system for improving network information resource distribution. FIG. 4 shows the structure of the system embodiment. The system includes an advertisement management sub-system 401, a user management sub-system 402, a webpage collection sub-system 403, a webpage analysis sub-system 404, an advertisement distribution sub-system 405, a statistics sub-system 406, an assignment sub-system 407 and an anti-fraud sub-system 408. The embodiment of the system will be described hereunder by taking network advertisements as an example.

The advertisement management sub-system 401 is used to manage advertisement information distributed by an advertisement distributor, and save and manage the advertisement information and information of the owner of the advertisement with a relation database. The user management sub-system 402 is used to record information of a virtual site and direct a user to embed advertisement codes in the virtual site. The user may log on the user management sub-system 402 to register a virtual site and to apply for putting advertisements, view information related to the virtual site such as access condition, advertisement putting amount, putting categories, advertisement revenue and the like, and modify configurations within the range of his right.

The webpage collection sub-system 403 is used to collect information of a desired webpage on a virtual site by using a webpage grabbing tool and save the information. The webpage analysis sub-system 404 is used to analyze the contents of the collected desired webpage and calculate the semantic space of the webpage by a series of operations including word splitting, filtering and the like, and then determine an advertisement matching the contents of the webpage. The advertisement distribution sub-system 405 is used to distribute an appropriate advertisement to the desired webpage through the network according the matching result from the webpage analysis sub-system 404. As described above, the dynamic distribution mode is employed and has two forms, i.e., Flash and Javascript, which will not be repeated here. The desired webpage refers to the webpage of the virtual site which is clicked and browsed. In practice, the webpage analysis sub-system 404 may be not provided, and instead, the advertisement information under a corresponding category may be assigned directly to the virtual site according to the advertisement categories configured by the user management sub-system 402.

The statistics sub-system 406 is used to make a statistics on virtual sites distributing information resources and calculate the utilization rate of the information resources on each of the virtual sites. For this embodiment, the statistics sub-system 406 is used to make a statistics on the browsing and clicking conditions of the advertisements distributed by the advertisement distribution sub-system 405 and subsequent effect, and calculate the actual revenue brought by the advertisements and according to the initial prices of the advertisements. The revenue assignment sub-system is used to assign a corresponding probability of obtaining a priority to each of the virtual sites according to the utilization rate, select randomly a virtual site through a verifiable random sequence generation approach by using the probability for obtaining a priority of each of the virtual sites, assign a priority to the selected virtual site. According to the priority, virtual site which has not distributed the information resources distribute the information resources. For this embodiment, the revenue assignment sub-system 407 is used to reassign the revenue to the virtual sites on the basis of the actual advertisement revenue by a verifiable random sequence generation approach; to obtain the priority, virtual sites which have not distribute information resources will distribute the information resources, thereby improving the distribution rate and utilization rate of the network resources. The specific distribution method may be understood by referring to the contents as described above. The anti-fraud sub-system 408 is used to filter out and deduct the advertisement revenue brought by fraud. Fraud may be found by analyzing the access regularity for the advertisements on a site. If the access regularity changes suddenly, it is possible that fraud is performed.

In FIG. 4, the procedure of data processing between the sub-systems of the system includes that: an advertisement distributor passes a system auditing, and puts various categories of advertisements in the advertisement management sub-system 401 for save. A user logs on the user management sub-system 402 to register a virtual site and apply for putting advertisements on his virtual site. When other users access the virtual site, the webpage collection sub-system 403 collects information of the webpage. The webpage analysis sub-system 404 analyzes the collected contents, match an appropriate advertisement from the advertisement management sub-system 401 with the contents, and then distribute the matched advertisement to the virtual site via the advertisement distribution sub-system 405. The browser returns a webpage containing the advertisement to the users. When a user browses or clicks the advertisement, advertisement revenue will be generated. The statistics sub-system 406 calculates actual revenue brought by the advertisement according to the browsing and clicking conditions or the subsequent effect, deducts the advertisement revenue brought by fraud according to a processing result of the anti-fraud sub-system 408, and sends the statistics result to the assignment sub-system 407. The assignment sub-system 407 reassigns the actual revenue of the advertisement to the virtual site according to a revenue assignment rule.

In the system as shown in FIG. 4, the parts that have not been described in detail may be understood by referring to the corresponding parts of the method as shown in FIG. 2 and FIG. 3, and will not be repeated here in view of the length of the description.

It should be noted that the site and the virtual site as mentioned in the present invention are the same entity.

The method and system for improving network information resource distribution have been detailed above. Specific embodiments have been used in the description to explain the principle and implementation of the present invention. The description on the embodiments is used only to facilitate the understanding of the inventive method and the key concept thereof. Modifications may be made to the embodiments and the application scope by those skilled in the art according to the concept of the present invention. In summary, the contents of the description should not be taken as a imitation to the present invention.

1. A method for improving network information resource distribution, comprising:
making a statistics on virtual sites distributing information resources, and calculating utilization rate of the information resources on each of the virtual sites;
assigning a corresponding probability of obtaining a priority to each of the virtual sites according to the utilization rate;
selecting randomly a virtual site by using the probability for obtaining a priority of each of the virtual sites;
assigning a priority to the selected virtual site;
distributing the information resources corresponding to the priority by virtual sites which have not distributed the information resources, according to the priority.

2. The method according to claim 1, wherein the process of selecting randomly a virtual site by using the probability for obtaining a priority of each of the virtual sites comprises:
implementing the obtaining a priority by assigning a corresponding quantity of numbers to each of the virtual sites according to the utilization rate of the information resources;
selecting one or more numbers randomly from all the numbers through a random algorithm;
assigning a priority to the virtual site or sites to which the selected number or numbers belong.

3. The method according to claim 2, wherein the random algorithm comprises:
collecting a number of raw data, and treating the raw data with a mathematic conversion to obtain an output data;
generating a random sequence through a random sequence generation function using the output data as a random seed; each value in the random sequence corresponding to one of the numbers.

4. The method according to claim 2, wherein the verifiable random sequence generation approach comprises:
selecting webpages with a great amount of data, and calculating text on each of the webpages;
selecting a function, and substituting the calculating result of each of the webpages into the function for multiple times of calculation, to obtain a verifiable random seed;
substituting the random seed into a random sequence generation function for calculation, to obtain a random sequence, each random number in the sequence corresponding to one of the numbers.

5. The method according to claim 1, further comprising:
distributing the information resources to the virtual site by embedding a dynamic Flash or a dynamic script on the virtual site.

6. The method according to claim 1, wherein the information resources are network advertisements, the utilization rate of the information resources is advertisement revenue, and the priority refers to the advertisement revenue reassigned to the selected virtual site.

7. A system for improving network information resource distribution, comprising:
a statistics sub-system, used to make a statistics on virtual sites distributing information resources and calculate utilization rate of the information resources on each of the virtual sites;
an assignment sub-system, used to assign a corresponding probability of obtaining a priority to each of the virtual sites according to the utilization rate, select randomly a virtual site through a verifiable random sequence generation approach by using the probability for obtaining a priority of each of the virtual sites, assign a priority to the selected virtual site, and distribute the information resources corresponding to the priority on virtual site which have not distributed the information resources, according to the priority.

8. The system according to claim 7, wherein the assignment sub-system comprises:
a probability assignment unit, used to assign a corresponding probability of obtaining a priority to each of the virtual sites according to the utilization rate;
a selection unit, used to select randomly a virtual site through a verifiable random sequence generation approach by using the probability for obtaining a priority of each of the virtual sites;
a priority assignment unit, used to assign a priority to the selected virtual site;
an information distribution unit, used to distribute the information resources corresponding to the priority on the virtual site which have not distributed the information resources, according to the priority.

9. The system according to claim 8, further comprising:
an advertisement distribution sub-system, used to distribute the information resources to the virtual site by embedding a dynamic Flash or a dynamic script on the virtual site.
